(19) United States
(12) Patent Application Publication
(10) Pub. No.: US 2014/0003047 A1
(43) Pub. Date: Jan. 2, 2014

(54) LUMINAIRE

(71) Applicant: Keiichi SHIMIZU, Kanagawa-ken (JP)

(72) Inventor: Keiichi SHIMIZU, Kanagawa-ken (JP)

(73) Assignee: Toshiba Lighting & Technology Corporation, Kanagawa-ken (JP)

(21) Appl. No.: 13/617,485

(22) Filed: Sep. 14, 2012

(30) Foreign Application Priority Data
Jun. 29, 2012 (JP) 2012-147198

(51) Int. Cl. F21V 13/02; F21V 3/00

(52) U.S. Cl. 362/235; 362/311.14; 362/296.01; 362/311.03

(57) ABSTRACT

According to one embodiment, a luminaire includes a main body, a light-emitting element, and a cover. The main body includes a top plate section having a rectangular plate shape and a pair of side plate sections provided to project to the top plate section and extending in the longitudinal direction of the top plate section. The light-emitting element is provided, in each of the side plate sections, on a side surface on the opposite side of the other side plate section. The cover is attached to the side plate section to project to the outer side of the side surface and configured to cover the light-emitting element and have transparency to light emitted from the light-emitting element.

### CROSS-REFERENCE TO RELATED APPLICATION

This application is based upon and claims the benefit of priority from. Japanese Patent Application No. 2012-147198, filed on Jun. 29, 2012; the entire contents of which are incorporated herein by reference.

### FIELD

Embodiments described herein relate generally to a luminaire in which a light-emitting element such as an LED (Light Emitting Diode) is used as a light source.

### BACKGROUND

In recent years, an LED is used as a light-emitting element of a base light that illuminates an entire room. However, the LED has a small light-emitting area and high luminance compared with an incandescent lamp and a fluorescent tube. Therefore, a user tends to feel a luminescent spot of the LED as a glare.

### DESCRIPTION OF THE DRAWINGS

FIG. 1 is an external perspective view of a luminaire according to an embodiment;

FIG. 2 is a schematic perspective view of main components of the luminaire;

FIGS. 3A and 3B are schematic end views of the main components of the luminaire;

FIG. 4 is a schematic perspective view of the main components of the luminaire;

FIG. 5 is a schematic diagram of a packaging form of the luminaire;

FIG. 6 is a schematic perspective view of main components of a luminaire according to another embodiment;

FIG. 7 is a schematic perspective view of a modification of a cover in the luminaire; and

FIGS. 8A and 8B are schematic end views of a modification of a main body in the luminaire.

### DETAILED DESCRIPTION

In general, according to one embodiment, a luminaire includes a main body, a light-emitting element, and a cover. The main body includes a top plate section having a rectangular plate shape and a pair of side plate sections provided to project to the top plate section and extending in the longitudinal direction of the top plate section. The light-emitting element is provided, in each of the side plate sections, on a side surface on the opposite side of the other side plate section. The cover is attached to the side plate section to project to the outer side of the side surface and configured to cover the light-emitting element and have transparency to light emitted from the light-emitting element.

Embodiments are explained below with reference to the accompanying drawings. In the drawings, the same components are denoted by the same reference numerals and signs.

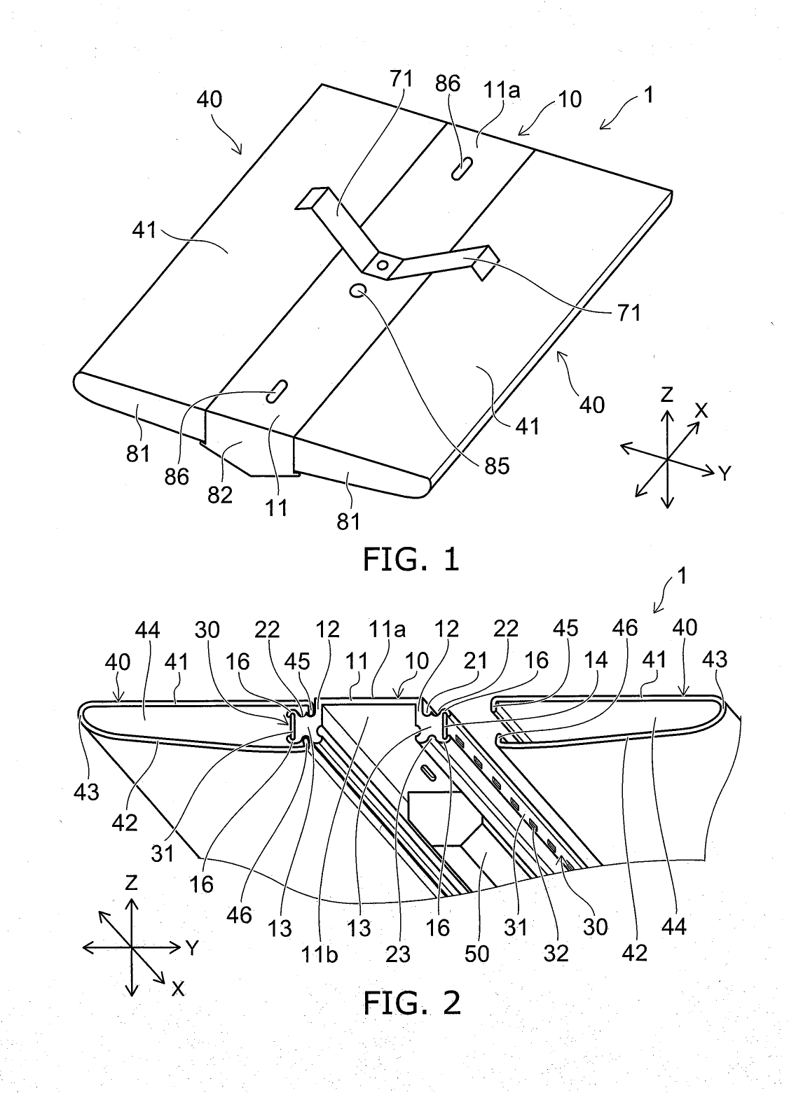

FIG. 1 is an external perspective view of a luminaire 1 according to an embodiment.

FIG. 2 is a schematic perspective view of a main body 10, a light source module 30, a cover 40, and a power supply unit 50 in the luminaire 1.

The luminaire 1 according to this embodiment includes the main body 10, the light source module 30, and a pair of covers 40. The light source modules 30 and the pair of covers 40 are attached to the main body 10.

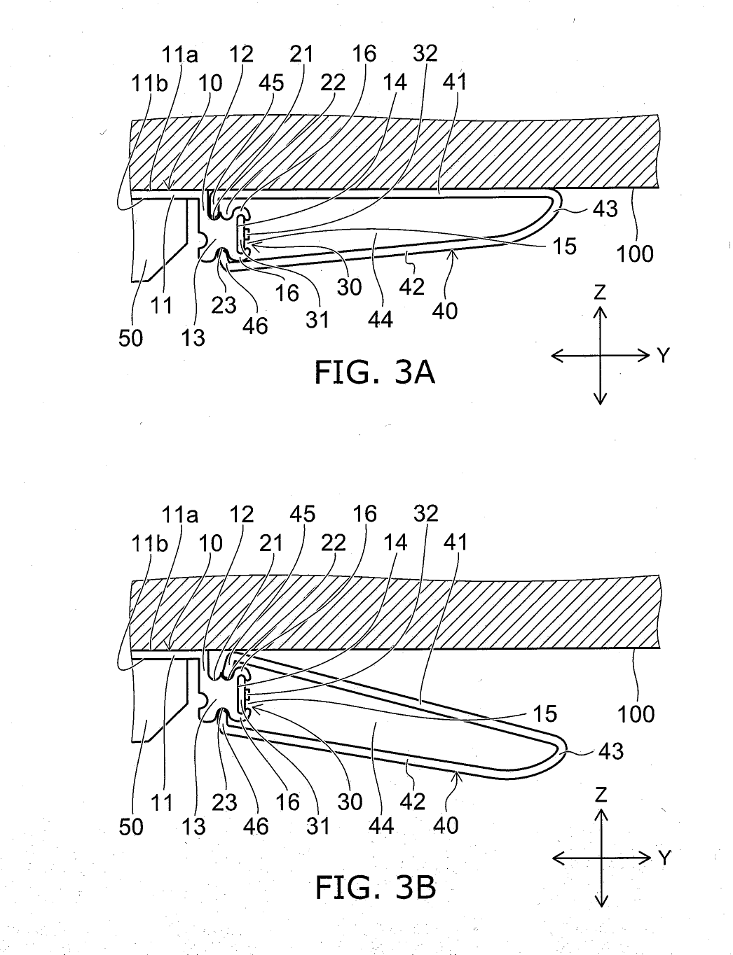

In a state shown in FIG. 2, one of the pair of covers 40 is not attached to the main body 10. A state in which the one cover 40 is attached to the main body 10 is shown in FIG. 3A.

In this specification, the longitudinal direction of the main body 10 is represented as a first direction X, the width direction of the main body 10, which is a direction orthogonal to the first direction X, is represented as a second direction Y, and a direction orthogonal to the first direction X and the second direction Y is represented as a third direction Z.

The main body 10 is made of a metal material in which a top plate section 11 and a pair of side plate sections 12 are integrally provided. The integrally formed main body 10 can be easily formed by extrusion molding. The main body 10 is, for example, an extrusion-molded product of aluminum. The main body 10 integrally formed of the metal material is excellent in thermal radiation properties.

Alternatively, the main body 10 is not limited to the integral configuration and may be configured by combining the top plate section 11 and the pair of side plate sections 12 that are separately provided. In this case, the existing trough main body or the like can be used as the main body 10. Further, an extrusion-molded member of aluminum used in a straight tube lamp can be attached to an iron plate main body to form the main body 10.

The top plate section 11 is formed in a rectangular plate shape extending in the first direction X. The top plate section 11 includes an upper surface 11a and a lower surface lib on the opposite side of the upper surface 11a. The luminaire 1 is attached to the ceiling. The upper surface 11a of the top plate section 11 is faced to the ceiling.

The side plate section 12 is provided to project to the lower surface lib side of the top plate section 11 from an end in the second direction Y in the top plate section 11. The side plate section 12 is provided perpendicularly to the top plate sections 11. The pair of side plate sections 12 extend in the first direction X and opposed to each other in parallel. The power supply unit 50 is provided in a space surrounded by the top plate section 11 and the pair of side plate sections 12 in the main body 10. The power supply unit 50 is fixed to the lower surface 11b of the top plate section 11 by, for example, screwing. The power supply unit 50 is connected to an external power supply through a power supply cable inserted through a through-hole 85 formed in the top plate section 11 shown in FIG. 1.

In each of the side plate sections 12, an outer wall section 13 extending in the first direction X in a columnar shape is provided on the opposite side of the other side plate section 12.

A side surface 14 of the outer wall section 13 extends in the first direction X. Lip sections 16 are provided at both ends in the third direction Z in the side surface 14. The lip sections 16 extend in the first direction X.

On the upper surface (a surface faced to the ceiling) of the outer wall section 13, two grooves 21 and 22 extending in the first direction X are formed. On the lower surface of the outer wall section 13 on the opposite side of the upper surface, one groove 23 extending in the first direction X is formed.

As shown in FIGS. 3A and 3B and FIG. 5, a concave section 15 extending in the first direction X is formed by the lip sections 16 and the side wall 14 provided in the outer wall section 13 of the side plate section 12. A substrate 31 of the light source module 30 is fit in the concave section 15. The light source module 30 includes the substrate 31 and a plurality of light-emitting elements 32 mounted on the substrate 31.

The substrate 31 is formed in a rectangular plate shape extending in the first direction X. After the substrate 31 is fit in the concave section 15, force is applied to the lip sections 16 to deform lip sections 16 and caulk the substrate 31. Consequently, the substrate 31 is held between the lip sections 16 and fixed to the side surface 14 of the side plate section 12. The substrate 31 maybe screwed to the side surface 14. With the fixing method by the caulking, the number of components can be reduced and workability is high compared with the screwing.

A not-shown wiring pattern is formed on the substrate 31. The light-emitting element 32 is mounted on the substrate 31 and electrically connected to the wiring pattern. The wiring pattern is electrically connected to the power supply unit 50 through a not-shown electric cable. A mounting surface of the substrate 31 is faced to the opposite side of the side surface 14 of the side plate section 12. The plurality of light-emitting elements 32 are mounted on the mounting surface and arrayed in the longitudinal direction of the substrate 31 (the first direction X).

A light emission surface of the light-emitting element 32 is faced to further outer side than the side surface 14 of the side plate section 12. The light emission surface of the light-emitting element 32 provided on one side plate section 12 and the light emission surface of the light-emitting element 32 provided on the other side plate section 12 face opposite directions each other. An optical axis of the light-emitting element 32 is parallel to or tilted with respect to the ceiling and the top plate section 11.

The light-emitting element 32 is, for example, a light-emitting diode (LED). If, for example, a gallium nitride (GaN) compound semiconductor is used as the material of an active layer of the LED, short-wavelength light having wavelength equal to or smaller than 500 nm is obtained. However, the material of the active layer is not limited to the gallium nitride compound semiconductor.

As the light-emitting element 32, besides the LED, for example, an organic light-emitting diode (OLED), an inorganic electroluminescence light-emitting element, an organic electroluminescence light-emitting element, and other electroluminescent light-emitting elements can be used.

The light-emitting element 32 includes a phosphor layer as well. In this embodiment, for example, an LED that emits blue light and a phosphor layer including a phosphor that absorbs the blue light (excitation light) and converts the blue light into yellow light are combined. Consequently, the light-emitting element 32 emits light of a white color or a bulb color as light of a mixed color of the blue light and the yellow light.

The pair of covers 40 are attached to respectively correspond to the pair of side plate sections 12. The cover 40 projects in the second direction Y from the side plate section 12 to the outer side of the side plate section 12 (in a direction away from the center position in the second direction Y of the main body 10) and extends in the first direction X.

The cover 40 includes an upper surface section 41 faced to the ceiling, a lower surface section 42 opposed to the upper surface section 41 across a space 44, and a side surface section 43. The cover 40 is an extraction-molded product of a resin material. The upper surface section 41, the lower surface section 42, and the side surface section 43 are integrally provided in the cover 40.

The upper surface section 41 and the lower surface section 42 are integrally connected via the side surface section 43 at one end in the second direction Y. The other end in the second direction Y in the cover 40 is opened.

At an end on the opening side in the upper surface section 41, an upper rib 45 projecting downward and extending in the first direction X is provided integrally with the upper surface section 41.

At an end on the opening side in the lower surface section 42, a lower rib 46 projecting upward and extending in the first direction X is provided integrally with the lower surface section 42.

The cover 40 is made of, for example, a milky-white resin material. The cover 40 has diffuse transparency to light emitted from the light-emitting element 32. For example, light diffusibility can be imparted to the cover 40 by dispersing a light diffusing substance such as powder or fine particle-like titanium oxide in the resin material. Alternatively, the light diffusibility can be imparted to the cover 40 by forming very small unevenness on the surface of the resin material.

The cover 40 is attached to the outer wall section 13 of the side plate section 12 to cover the light-emitting element 32. The lower rib 46 engages in the groove 23 formed in the lower surface of the outer wall section 13 of the side plate section 12. The upper rib 45 engages in one of the two grooves 21 and 22 formed on the upper surface of the outer wall section 13 of the side plate section 12.

In a state shown in FIG. 3A, the upper rib 45 engages in the groove 21 on a side close to the center in the second direction Y (the inner side) of the main body 10. In a state shown in FIG. 3B, the upper rib 45 engages with the groove 22 on a side far from the center in the second direction Y of the main body 10.

The cover 40 is made of a resin material. The cover 40 has flexibility or elasticity. If the cover 40 is deformed from a natural state to separate the upper surface section 41 and the lower surface section 42 with the side surface section 43 as a fulcrum, an elastic restoring force acts in a direction in which the upper rib 45 and the lower rib 46 come close to each other. With the elastic restoring force, the upper rib 45 comes into press contact with and engages in the groove 21 or 22, the lower rib 46 comes into press contact with and engages in the groove 23, and a stable attached state of the cover 40 to the outer wall section 13 is maintained.

The upper rib 45 can be disengaged from the groove 21 or the groove 22, the lower rib 46 can be disengaged from the groove 23, and the cover 40 can be detached from the outer wall section 13 by deforming the upper surface section 41 and the lower surface section 42 to be separated from each other in a state in which the cover 40 is attached to the outer wall section 13. In other words, the cover 40 is detachably attached to the side wall section 12.

In a state in which the cover 40 is attached to the sidewall section 12, the light-emitting element 32 faces the space 44 between the upper surface section 41 and the lower surface section 42 in the cover 40. The light emission surface of the light-emitting element 32 is faced to the side surface section 43 side of the cover 40.

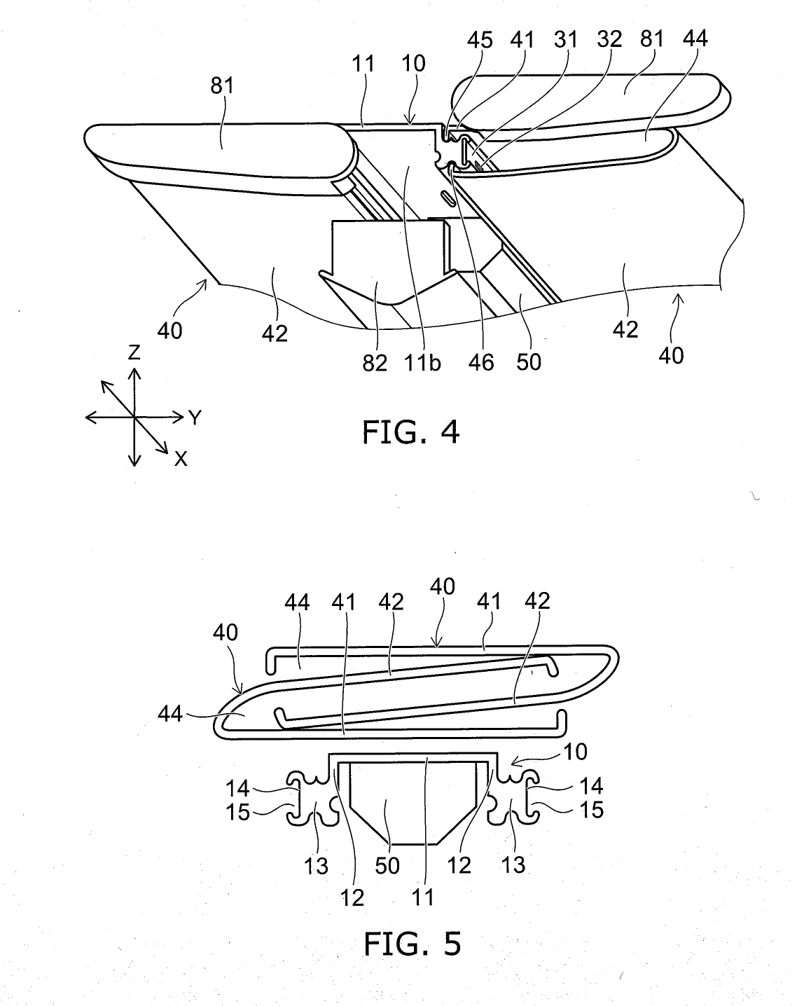

As shown in FIGS. 1 and 4, an end cover 81 is attached to an end in the first direction X of the cover 40. The space 44 in the cover 40 is closed by the end cover 81. Alternatively, the luminaire 1 including a larger light-emitting surface can be formed by connecting a plurality of covers 40 in the first direction X without attaching the end cover 81.

A space surrounded by the top plate section 11 and the pair of side plate sections 12 in the main body 10 is closed by a top cover 82. The top cover 82 is placed over an end face in the first direction X of the end cover 81 and the lower surface of the lower surface section 42 of the cover 40 to close a space on the lower side of the top plate section 11. The end cover 81 and the top cover 82 are made of, for example, silicone resin.

As shown in FIG. 1, a pair of attachment springs 71 are provided on the upper surface 11a faced to the ceiling in the top plate section 11. The pair of attachment springs 71 are integrally molded by machining a metal plate. The center of the attachment springs 71 is, for example, screwed to the upper surface 11a of the top plate section 11.

The luminaire 1 can be easily attached to the ceiling by engaging the attachment springs 71 in an attachment hole formed in the ceiling. As the attachment hole, an attachment hole formed for a downlight can be used. Therefore, according to this embodiment, instead of the downlight, a thin luminaire (base light) 1 having a light-emitting surface larger than that of the downlight can be attached to a place where the downlight is attached.

The attachment springs 71 can be attached to the top section 11 to be rotatable about an attachment section (e.g., a pin-like member) to the upper surface 11a of the top plate section 11. Consequently, in a state in which the luminaire 1 is attached to the ceiling via the attachment springs 71, the luminaire 1 can be adjusted to desired posture by manually operating the luminaire 1 and easily rotating the luminaire 1 about the vertical axis.

According to this embodiment, the light-emitting element 32 faces in a lateral direction parallel to or slightly tilting with respect to the ceiling surface rather than a right downward direction perpendicular to the ceiling surface. Therefore, since the light-emitting element 32 is not directly viewed by the user present below the luminaire 1, glare felt by the user can be suppressed.

A part of light emitted from the light-emitting element 32 is made incident on the lower surface section 42 of the cover 40. The light is diffused and transmitted through the lower surface section 42 and emitted downward under the luminaire 1. Since the light made incident on the lower surface section 42 is diffused and transmitted through the lower surface section 42, a uniform light-emitting surface is obtained over a wide range of the lower surface section 42.

A part of the light emitted from the light-emitting element 32 is made incident on the side surface section 43 of the cover 40 as well. According to this embodiment, since the light emission surface of the light-emitting element 32 faces the lateral direction, it is possible to increase an amount of light made incident on the side surface section 43.

Therefore, light can be distributed to the ceiling surface side around the luminaire 1 by emitted light from the side surface section 43. Consequently, it is possible to increase, according to an indirect illumination effect, a feeling of brightness of a space where the user is present and create spread and depth feelings of the space.

Glare tends to be felt more intense as the environment is darker. Therefore, when the ceiling surface around the luminaire 1 is lit by the emitted light from the side surface section 43, it is possible to increase an apparent light-emitting area of the luminaire 1, improve uniformity of luminance distribution, and further reduce the glare.

The cover 40 can be attached to the side plate section 12 with the angle of the upper surface section 41 and the lower surface section 42 changed with respect to the optical axis of the light-emitting element 32.

For example, as shown in FIG. 3B, the upper surface section 41 can be separated from a ceiling surface 100 and tilted with respect to the ceiling surface 100 by engaging the upper rib 45 of the cover 40 in the groove 22 further on the outer side in the outer wall section 13.

Consequently, it is possible to increase an amount of incident light from the light-emitting element 32 on the upper surface section 41 of the cover 40 and increase an amount of distributed light to the ceiling surface 100 side with the emitted light from the upper surface section 41. As a result, it is possible to increase the indirect illumination effect and the glare suppression effect.

In the luminaire 1 according to this embodiment, the light-emitting element 32 is not faced vertically downward. Light is emitted in the lateral direction and led downward making use of the diffusibility of the cover 40. In other words, the plurality of light-emitting elements 32 are arranged along the first direction X on the side surface 14 of the main body 10 having a bar shape extending in the first direction X rather than being faced vertically downward and arranged over a large surface.

Therefore, it is possible to reduce the plane size of the main body 10 that supports the light-emitting element 32. The cover 40 is detachably attachable to the main body 10 and can be removed.

In FIG. 5, a packaging form of the main body 10 and the pair of covers 40 is shown.

As shown in FIG. 5, the upper surface section 41 or the lower surface section 42 of one cover 40 is inserted into the space 44 of the other cover 40, the upper surface section 41 or the lower surface section 42 of the other cover 40 is inserted into the space 44 of the one cover 40, and the pair of covers 40 are placed one on top of the other. Consequently, it is possible to house the pair of covers 40 in a space having a plane size of one cover 40 while reducing height. According to this embodiment, it is possible to reduce the size of a packaging space of the luminaire 1 as well as the size of the main body 10.

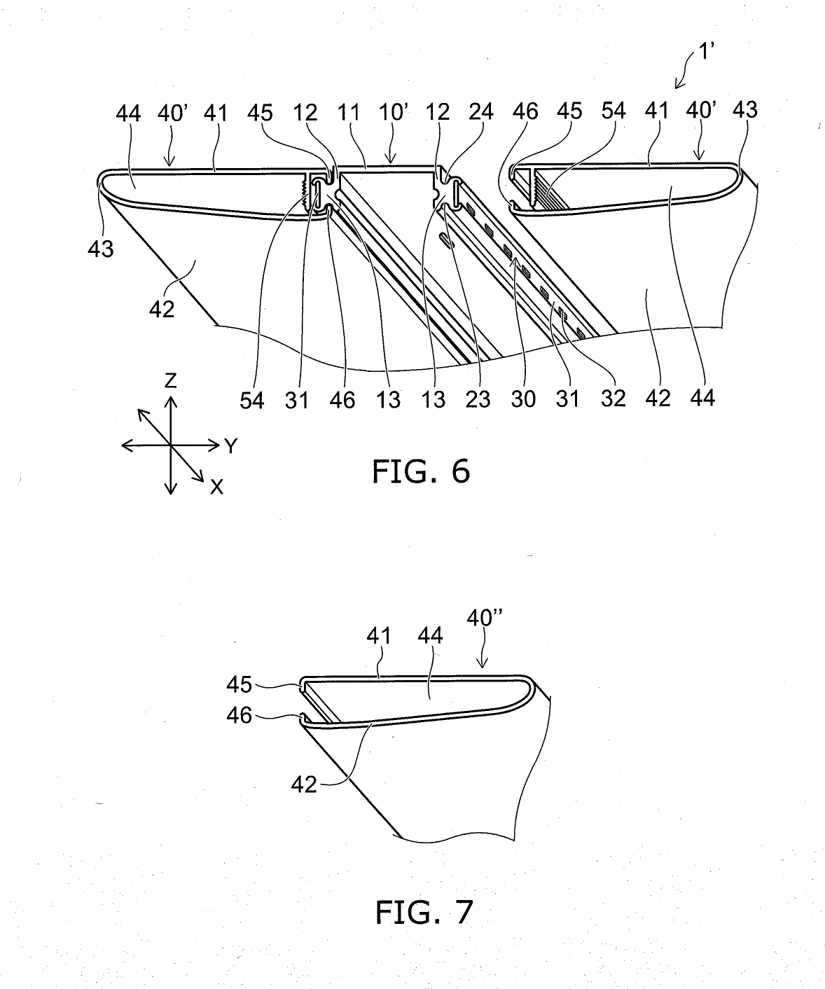

FIG. 6 is a schematic perspective view of a main body 10′, the light source module 30, and a cover 40′ in a luminaire 1′ according to another embodiment.

In the main body 10′ in this embodiment, only one groove 24 is formed on the upper surface of the outer wall section 13. However, as in the embodiment explained above, the two grooves 21 and 22 may be formed to enable an attachment angle of the cover 40′ to be changed.

The cover 40′ in this embodiment is different from the cover 40 in the embodiment explained above in that the cover 40′ includes a luminous-intensity-distribution control section 54.

The luminous-intensity-distribution control section 54 is provided in the position of the opening side (the light-emitting element 32 side) in the space 44 formed between the upper surface section 41 and the lower surface section 42. The cover 40 including the upper surface section 41, the lower surface section 42, the side surface section 43, and the luminous-intensity-distribution control section 54 is formed by, for example, extrusion molding of a resin material.

The luminous-intensity-distribution control section 54 extends from the upper surface section 41 to the lower surface section 42 and extends in the first direction X. Unevenness is formed on a surface facing the side surface section 43 side in the luminous-intensity-distribution control section 54. A plurality of concave sections and convex sections are repeated in the third direction Z. Each of the concave sections and convex sections extends in the first direction X.

Light emitted from the light-emitting element 32 can be diffused in the height direction of the space 44 in the cover 40 (the third direction Z) by the luminous-intensity-distribution control section 54 having such structure.

FIG. 7 is a diagram of a cover 40″ in another specific example.

The upper surface section 41 and the lower surface section 42 in the cover 40″ have different transmittances to light emitted from the light-emitting element 32.

The lower surface section 42 is formed of milky-white resin. The lower surface section 42 has diffuse transparency to light. The upper surface section 41 is formed of white resin. The upper surface section 41 has reflectivity to light emitted from the light-emitting element 32. In other words, the transmittance of the lower surface section 42 is higher than the transmittance of the upper surface section 41 and the reflectance of the upper surface section 41 is higher than the reflectance of the lower surface section 42. It is possible to improve downward light extraction efficiency by imparting reflectivity to the upper surface section 41.

The cover 40″ can be formed by, for example, a two-color molding method for resin. Alternatively, when the transmittance and the reflectance of the cover 40″ are partially changed, a method of partially applying or printing a reflective material and forming the cover 40″ is also possible. Alternatively, it is also possible to change the thickness of the cover 40″ and control light transmittance.

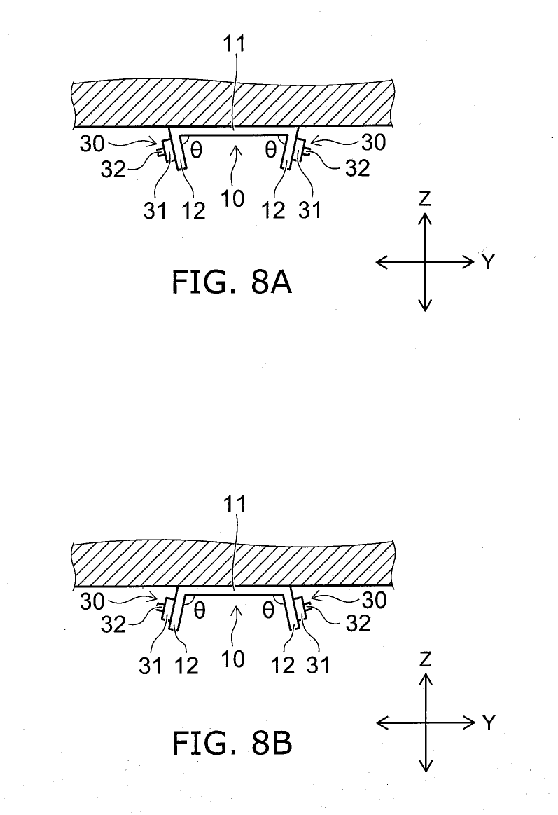

In the main body 10, the side plate section 12 is not limited to be perpendicular to the top plate section 11 and may tilt with respect to the top plate section 11 as shown in FIG. 8A or 8B. In FIGS. 8A and 8B, the side plate section 12 is simplified and shown as a simple plate.

In FIG. 8A, an angle θ formed by the top plate section 11 and the side plate section 12 is smaller than 90 degrees. The light-emitting element 32 is faced obliquely downward.

In FIG. 8B, the angle θ formed by the top plate section 11 and the side plate section 12 is larger than 90 degrees. The light-emitting element 32 is faced obliquely upward to the ceiling side.

In other words, the luminous-intensity distribution control can be performed according to the angle θ of the side plate section 12 with respect to the top plate section 11.

The power supply unit 50 is not limited to be attached to the main body 10 and may be set above the ceiling though an attachment hole. It is possible to reduce the size, the thickness, and the weight of the main body 10 by arranging the power supply unit 50 above the ceiling.

Alternatively, a power supply unit set above the ceiling for the existing downlight can also be used.

The luminaire is not limited to be attached to the ceiling via the attachment springs 71. For example, the luminaire 1 can be attached to the ceiling by coupling bolts, which are suspended from the ceiling, to holes 86 for attachment formed in the top plate section 11 shown in FIG. 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a main body including a top plate section having a rectangular plate shape and a pair of side plate sections provided to project to the top plate section and extending in a longitudinal direction of the top plate section;
a light-emitting element provided, in each of the side plate sections, on a side surface on an opposite side of the other side plate section; and
a cover attached to the side plate section to project to an outer side of the side surface and configured to cover the light-emitting element and have transparency to light emitted from the light-emitting element.

2. The luminaire according to claim 1, wherein the cover is detachably attachable to the side plate section with an attachment angle changed.

3. The luminaire according to claim 1, wherein
the cover includes an upper surface section faced to a ceiling and a lower surface section opposed to the upper surface section across a space, and
the light-emitting element faces the space.

4. The luminaire according to claim 3, wherein the cover is attached to the side plate section such that angles of the upper surface section and the lower surface section can be changed with respect to an optical axis of the light-emitting element.

5. The luminaire according to claim 3, wherein the upper surface section and the lower surface section of the cover have different transmittances to the light emitted from the light-emitting element.

6. The luminaire according to claim 3, wherein the cover further includes a luminous-intensity-distribution control section provided in a position on the light -emitting element side in the space.

7. The luminaire according to claim 1, wherein the cover has reflectivity to the light emitted from the light-emitting element.

8. The luminaire according to claim 1, wherein the cover has diffusibility to the light emitted from the light-emitting element.

9. The luminaire according to claim 1, wherein the light-emitting element is mounted on a substrate caulked and fixed to the side plate section.

10. The luminaire according to claim 1, further comprising an attachment spring provided on an upper surface faced to a ceiling in the top plate section and capable of engaging in an attachment hole formed in the ceiling.

11. The luminaire according to claim 1, further comprising a power supply unit provided in a space surrounded by the top plate section and the pair of side plate sections in the main body.

12. The luminaire according to claim 1, wherein the pair of side plate sections are provided perpendicularly to the top plate section.

13. The luminaire according to claim 1, wherein the pair of side plate sections are provided to tilt with respect to the top plate section.

14. The luminaire according to claim 1, wherein the main body is made of a metal material in which the top plate section and the side plate section are integrally provided.

15. The luminaire according to claim 1, wherein a plurality of the light-emitting elements are arrayed in the longitudinal direction of the top plate section.

16. A luminaire comprising:
a main body having light-emitting elements mounted therein and oriented to emit light in directions that are substantially parallel to a horizontal plane during operation; and
at least one cover attached to the main body to cover the light-emitting elements and having transparent top and bottom portions that extend generally in the light emitting direction of the light-emitting elements.

17. The luminaire according to claim 16, wherein the at least one cover includes a first cover having top and bottom portions that extend in a first direction and a second cover having top and bottom portions that extend in a second direction that is opposite to the first direction.

18. The luminaire according to claim 16, wherein the main body includes first and second attachment sections for said at least one cover, wherein said at least one cover is attachable to one the first and second attachment sections as a way to change the extension direction of the top portion.

19. The luminaire according to claim 16, wherein the light-emitting elements are oriented to emit light in directions that are angled slightly downward with respect to the horizontal plane.

20. The luminaire according to claim 16, wherein the light-emitting elements are oriented to emit light in directions that are angled slightly upward with respect to the horizontal plane.
